(19) United States
(12) Patent Application Publication
(10) Pub. No.: US 2022/0066420 A1
(43) Pub. Date: Mar. 3, 2022

(54) UNIVERSAL JOINT AND METHOD OF MAKING THE SAME

(71) Applicant: SUNG YU INDUSTRY CO.,LTD., Taichung City (TW)

(72) Inventor: CHING-HSIEN CHU, Taichung City (TW)

(21) Appl. No.: 17/005,254

(22) Filed: Aug. 27, 2020

(51) Int. Cl. G05B 19/4155

(52) U.S. Cl. CPC G05B 19/4155; G05B 2219/36196; G05B 2219/45135

(57) ABSTRACT

A universal joint contains: a first connector, a second connector, a connection shaft, a first bolt, a second bolt, a first spring, and a second spring. The first connector includes a fitting orifice for fitting with a socket, two first rotatable tabs, and a first accommodation space defined between the two first rotatable tabs. The second connector includes a coupling post for connecting with a wrench, two second rotatable tabs, and a second accommodation space defined between the two second rotatable tabs and configured to receive the connection shaft. The first bolt is inserted through the two first rotatable tabs and the connection shaft, and the second bolt is inserted through the two second rotatable tabs and the connection shaft. When the two first rotatable tabs and the two second rotatable tabs are connected with the connection shat, the first rotatable tabs intersect with the second rotatable tabs.

### FIELD OF THE INVENTION

The present invention relates to a universal joint which contains the first connector, the third connector, and the connection shaft connected tightly so that the universal joint is aligned with a desired position exactly.

### BACKGROUND OF THE INVENTION

A conventional universal joint contains a first portion having a fitting recess configured to receive a screw bolt, and the first portion having a first connector; a second portion having a drive bolt configured to mesh with a tool head, and the second portion having a second connector; at least one connection element coupled with the first connector and the second connector, wherein the at least one connection element transmits torque between the first portion and the second portion so as to drive the first portion and the second portion to rotate.

However, the first portion and the second portion do not have a spring, thus causing vibration easily.

To overcome above-mentioned defects, a spring is provided to an improved universal joint so as to connecting the first portion, the second portion, and the at least one connection element flexibly and to have firm operation of the improved universal joint.

But the improved universal joint is connected in a riveting manner, so it is easy to remove when operating the universal joint with an electrical tool or a pneumatic tool.

The present invention has arisen to mitigate and/or obviate the afore-described disadvantages.

### SUMMARY OF THE INVENTION

The primary aspect of the present invention is to provide a universal joint which contains the first connector, the third connector, and the connection shaft connected tightly so that the universal joint is aligned with a desired position exactly.

To obtain the above mentioned aspect, a universal joint provided by the present invention contains: a first connector, a second connector, a connection shaft, a first bolt, a second bolt, a first spring, and a second spring.

The first connector includes a fitting orifice defied on a first end thereof and configured to fit with a socket, two first rotatable tabs extending from a second end of the first connector, and a first accommodation space defined between the two first rotatable tabs and configured to receive the connection shaft.

The second connector includes a coupling post extending from a first end thereof and configured to connect with a wrench, two second rotatable tabs extending from a second end of the second connector, and a second accommodation space defined between the two second rotatable tabs and configured to receive the connection shaft.

The first bolt is inserted through the two first rotatable tabs and the connection shaft, and the second bolt is inserted through the two second rotatable tabs and the connection shaft.

When the two first rotatable tabs and the two second rotatable tabs are connected with a first end and a second end of the connection shaft, the first rotatable tabs intersect with the second rotatable tabs.

The connection shaft includes one of two apertures adjacent to the first bolt so as to receive the first spring, and the connection shaft includes the other aperture proximate to the second bolt so as to receive the second bolt, wherein the first spring abuts against the two first rotatable tabs and the connection shaft, and the second spring abuts against the two second rotatable tabs and the connection shaft.

Preferably, two ends of the first bolt are cold soldered so as to be integrally formed with the two first rotatable tabs, and two ends of the second bolt are cold soldered so as to be integrally formed with the two second rotatable tabs.

Preferably, connection portions of the two rotatable tabs and the second rotatable tabs are ground so as to produce a smooth surface on the connection portions of the two rotatable tabs and the second rotatable tabs.

### BRIEF DESCRIPTION OF THE DRAWINGS

FIG. 1 is a perspective view showing the exploded components of a universal joint according to a first embodiment of the present invention.

FIG. 2 is a cross sectional view showing the assembly of the universal joint according to the first embodiment of the present invention.

FIG. 3 is a cross view showing a step of making the universal joint according to the first embodiment of the present invention.

FIG. 4 is a cross view showing another step of making the universal joint according to the first embodiment of the present invention.

FIG. 5 is a perspective view showing the assembly of the universal joint according to the first embodiment of the present invention.

FIG. 6 is a flow chart of a method of making the universal joint according to the first embodiment of the present invention.

FIG. 7 is a perspective view showing the exploded components of a universal joint according to a second embodiment of the present invention.

FIG. 8 is a cross sectional view showing the assembly of the universal joint according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

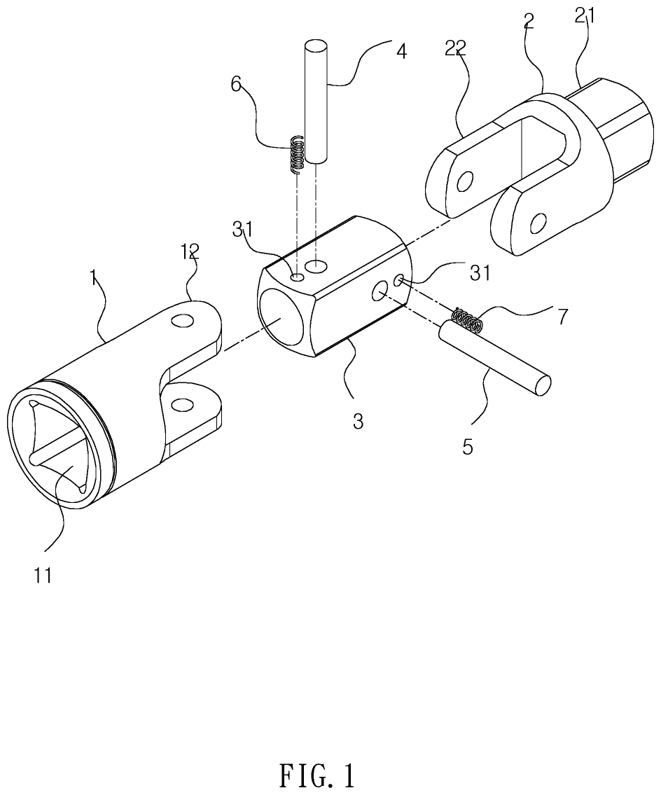

With reference to FIGS. 1 to 5, a universal joint according to a first embodiment of the present invention comprises: a first connector 1, a second connector 2, a connection shaft 3, a first bolt 4, a second bolt 5, a first spring 6, and a second spring 7.

The first connector 1 includes a fitting orifice 11 defined on a first end thereof and configured to fit with a socket, two first rotatable tabs 12 extending from a second end of the first connector 1, and a first accommodation space defined between the two first rotatable tabs 12 and configured to receive the connection shaft 3.

The second connector 2 includes a coupling post 21 extending from a first end thereof and configured to connect with a wrench, two second rotatable tabs 22 extending from a second end of the second connector 2, and a second accommodation space defined between the two second rotatable tabs 22 and configured to receive the connection shaft 3.

The first bolt 4 is inserted through the two first rotatable tabs 12 and the connection shaft 3, and the second bolt 5 is inserted through the two second rotatable tabs 22 and the connection shaft 3.

When the two first rotatable tabs 12 and the two second rotatable tabs 22 are connected with a first end and a second end of the connection shaft 3, the first rotatable tabs 12 intersect with the second rotatable tabs 22.

The connection shaft 3 includes one of two apertures 31 adjacent to the first bolt 4 so as to receive the first spring 6, and the connection shall 3 includes the other aperture 31 proximate to the second bolt 5 so as to receive the second bolt 5, wherein the first spring 6 abuts against the two first rotatable tabs 12 and the connection shaft 3, and the second spring 7 abuts against the two second rotatable tabs 22 and the connection shaft 3. Two ends of the first bolt 4 are cold soldered so as to be integrally formed with the two first rotatable tabs 12, and two ends of the second bolt 5 are cold soldered so as to be integrally formed with the two second rotatable tabs 22.

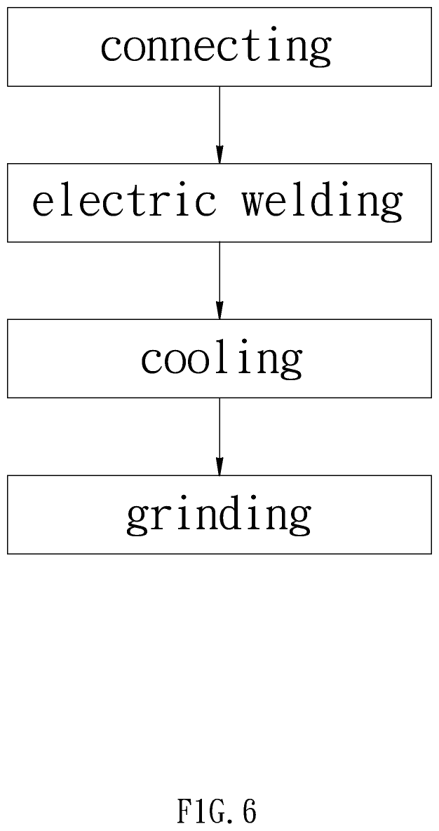

Referring to FIG. 6, a method of making the universal joint comprises steps of: connecting, electric welding, cooling, and grinding.

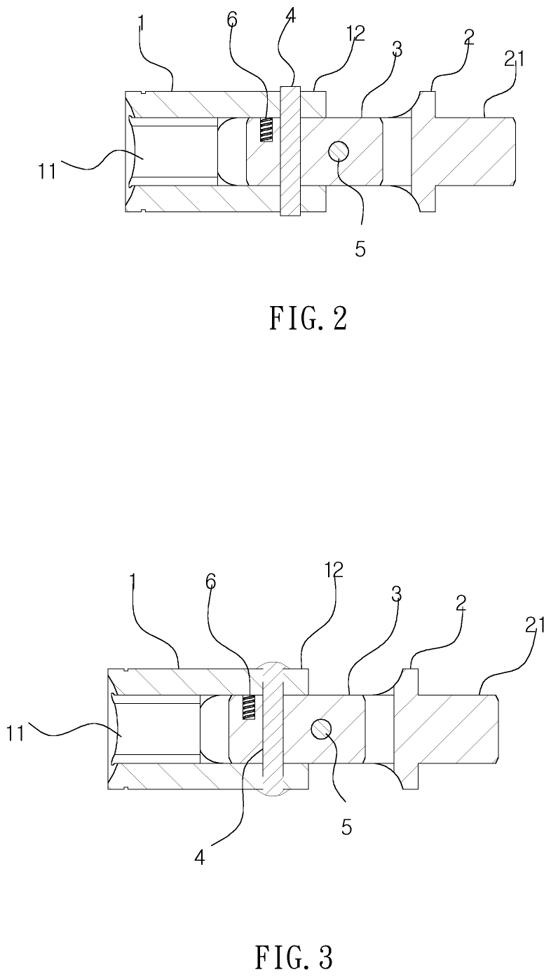

In the connecting steps, the first spring is received by the one aperture of the connection shaft, and the second spring is accommodated by the other aperture of the connection shaft. Then, the first spring is pressed to the first accommodation space between the two first rotatable tabs, and the second spring is pressed to the second accommodation space between the two second rotatable tabs. Thereafter, the first bolt is inserted through the two first rotatable tabs and the connection shat, and the second bolt is inserted through the second rotatable tabs and the connection shaft, such that the first connector, the second connector, and the connection shaft are rotatably connected, as shown in FIGS. 1 and 2.

In the electric welding step, the two ends of each of the first and second bolts are electrically weld so that the two ends of the first bolt are integrally formed with the two first rotatable tabs, and the two ends of the second bolt are integrally formed with the two second rotatable tabs, as shown in FIG. 3.

In the cooling step, a semi-finished universal joint is put in a room temperature so as to cool the semi-finished universal joint to the room temperature.

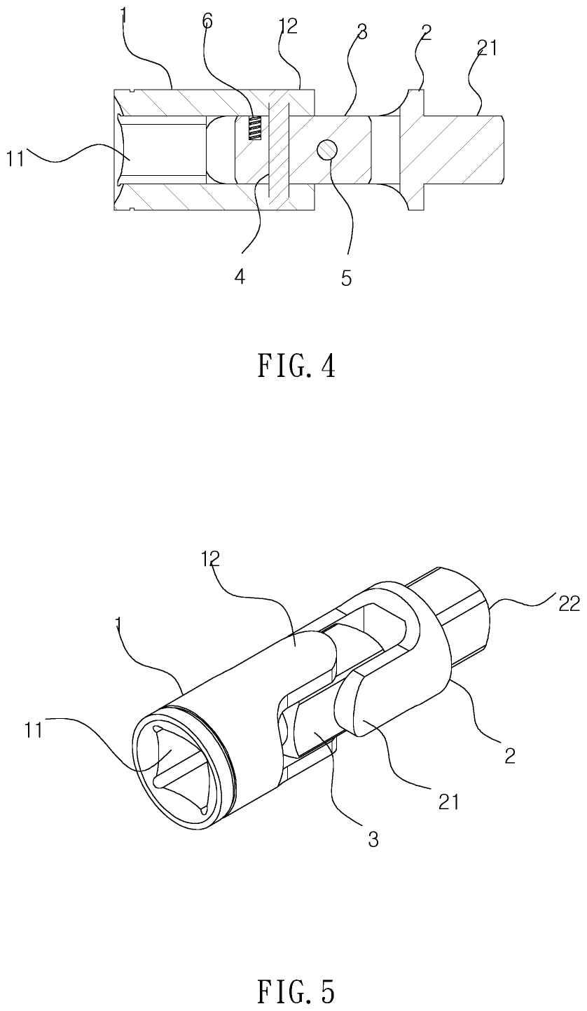

In the grinding step, connection portions of the two rotatable tabs and the second rotatable tabs are ground so as to produce a smooth surface on the connection portions of the two rotatable tabs and the second rotatable tabs, as illustrated in FIGS. 4 and 5.

Thereby, the universal joint of the present invention has advantages as follows:

1. The first connector, the third connector, and the connection shaft are connected tightly so that the universal joint is aligned with a desired position exactly.

2. The first bolt and the second bolt are cold soldered so as to be integrally formed with the two first rotatable tabs and the two second rotatable tabs, thus reinforcing connection portions of the first bolt and the second bolt with the two first rotatable tabs and the two second rotatable tabs. Preferably, the connection portions of the two rotatable tabs and the second rotatable tabs are ground, thus obtaining aesthetic appearance.

3. The two ends of the first bolt are cold soldered so as to be integrally formed with the two first rotatable tabs, and two ends of the second bolt are cold soldered so as to be integrally formed with the two second rotatable tabs, thus avoiding deformation of the first spring and the second spring.

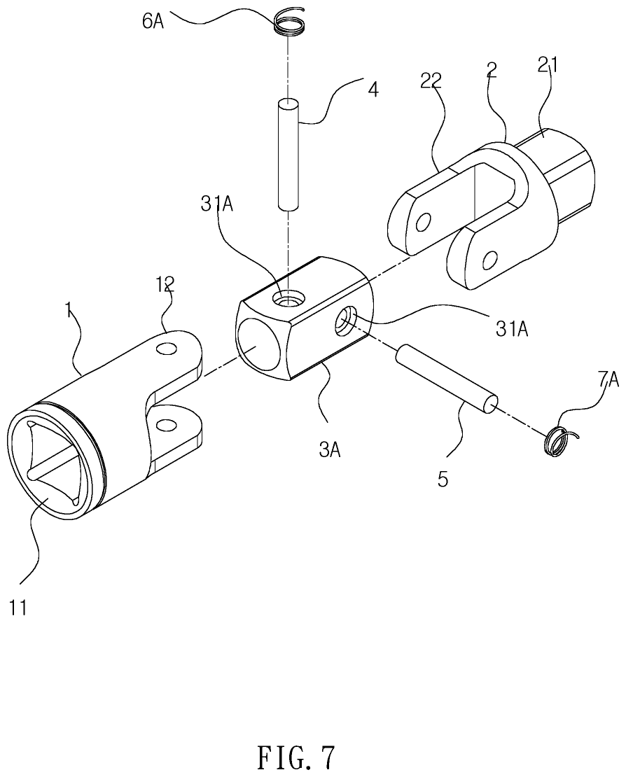

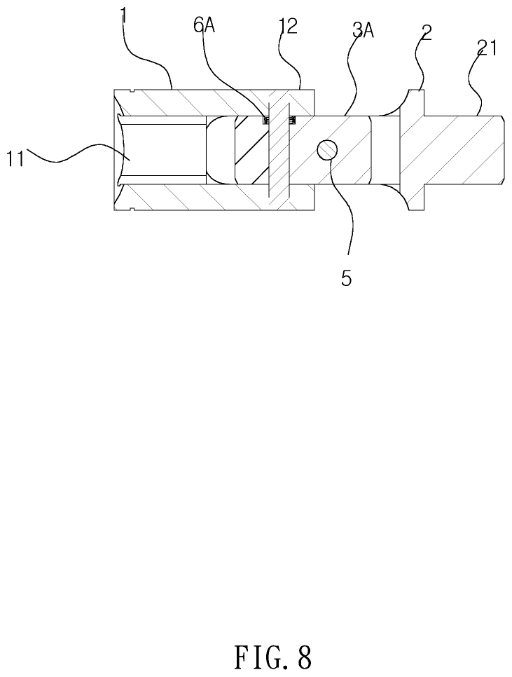

As illustrated in FIGS. 7 and 8, a universal joint of a second embodiment comprises: a connection shaft 3A including two stepped apertures 31A, wherein one of the two stepped apertures 31A is configured to receive a first bolt 4 and a first spring 6A, and the other stepped aperture 31A is configured to accommodate a second bolt 5 and a second spring 7A.

While various embodiments in accordance with the present invention have been shown and described, it is clear to those skilled in the art that further embodiments may be made without departing from the scope of the present invention.

What is claimed is:

1. A method of making the universal joint comprising steps of: connecting, electric welding, cooling, and grinding;
wherein in the connecting steps, a first spring is received by one of two apertures of a connection shaft, and a second spring is accommodated by the other aperture of the connection shaft, then the first spring is pressed to a first accommodation space between two first rotatable tabs, and the second spring is pressed to a second accommodation space between two second rotatable tabs, thereafter a first bolt is inserted through the two first rotatable tabs and the connection shaft, and a second bolt is inserted through the second rotatable tabs and the connection shaft, such that a first connector, a second connector, and the connection shaft are rotatably connected;
wherein in the electric welding step, two ends of each of the first and second bolts are electrically weld so that the two ends of the first bolt are integrally formed with the two first rotatable tabs, and the two ends of the second bolt are integrally formed with the two second rotatable tabs;
wherein in the cooling step, a semi-finished universal joint is put in a room temperature so as to cool the semi-finished universal joint to the room temperature;
wherein in the grinding step, connection portions of the two rotatable tabs and the second rotatable tabs are ground so as to produce a smooth surface on the connection portions of the two rotatable tabs and the second rotatable tabs.

2. A universal joint comprising: a first connector, a second connector, a connection shaft, a first bolt, a second bolt, a first spring, and a second spring;
wherein the first connector includes a fitting orifice defined on a first end thereof and configured to fit with a socket, two first rotatable tabs extending from a second end of the first connector, and a first accommodation space defined between the two first rotatable tabs and configured to receive the connection shaft;
wherein the second connector includes a coupling post extending from a first end thereof and configured to connect with a wrench, two second rotatable tabs extending from a second end of the second connector, and a second accommodation space defined between the two second rotatable tabs and configured to receive the connection shaft;
wherein the first bolt is inserted through the two first rotatable tabs and the connection shaft, and the second bolt is inserted through the two second rotatable tabs and the connection shaft;
wherein when the two first rotatable tabs and the two second rotatable tabs are connected with a first end and a second end of the connection shaft, the first rotatable tabs intersect with the second rotatable tabs;
wherein the connection shaft includes one of two apertures adjacent to the first bolt so as to receive the first spring, and the connection shaft includes the other aperture proximate to the second bolt so as to receive the second bolt, wherein the first spring abuts against the two first rotatable tabs and the connection shaft, and the second spring abuts against the two second rotatable tabs and the connection shaft;
wherein two ends of the first bolt are cold soldered so as to be integrally formed with the two first rotatable tabs, and two ends of the second bolt are cold soldered so as to be integrally formed with the two second rotatable tabs;
wherein connection portions of the two rotatable tabs and the second rotatable tabs are ground so as to produce a smooth surface on the connection portions of the two rotatable tabs and the second rotatable tabs.
